(19) United States
(12) Patent Application Publication
(10) Pub. No.: US 2017/0272889 A1
(43) Pub. Date: Sep. 21, 2017

(54) SOUND REPRODUCTION SYSTEM

(71) Applicant: SOCIONEXT INC., Kanagawa (JP)

(72) Inventors: Kazutaka ABE, Osaka (JP); Shuji MIYASAKA, Osaka (JP)

(21) Appl. No.: 15/610,941

(22) Filed: Jun. 1, 2017

Related U.S. Application Data
(63) Continuation of application No. PCT/JP2015/005684, filed on Nov. 13, 2015.

(30) Foreign Application Priority Data
Dec. 3, 2014 (JP) 2014-245218

(51) Int. Cl. H04S 7/00; H04S 3/00; H04R 5/02; A63F 13/54

(52) U.S. Cl. CPC H04S 7/303; A63F 13/54; H04S 3/008; H04R 5/02; H04S 2400/01; H04S 2400/11; H04S 2420/07; H04S 2420/01

(57) ABSTRACT

A sound reproduction system includes a sound processing device connected to a stationary first output device including a plurality of sound output units and a portable second output device including a plurality of sound output units. In the sound reproduction system, the sound processing device generates a first sound output signal to be output to the first output device and a second sound output signal, which is different from the first sound output signal, to be output to the second output device. At least the second sound output signal out of the first and second sound output signals includes a signal that is obtained by performing 3-D sound processing.

### CROSS REFERENCE TO RELATED APPLICATIONS

This is a continuation application of PCT International Application No. PCT/JP2015/005684 filed on Nov. 13, 2015, designating the United States of America, which is based on and claims priority of Japanese Patent Application No. 2014-245218 filed on Dec. 3, 2014. The entire disclosures of the above-identified applications, including the specifications, drawings and claims are incorporated herein by reference in their entirety.

### FIELD

The present disclosure relates to a sound reproduction system for reproducing three-dimensional (3-D) sound.

### BACKGROUND

The use of multichannel audio signals, such as 5.1 channel and 7.1 channel audio signals, has expanded not only in films and music but also in games. Multichannel loudspeakers located at predetermined positions surrounding a listener provide highly realistic audio reproduction. To cope with some difficult cases of installing 5.1 channel and 7.1 channel loudspeakers, 3-D sound technology has been developed that enables conventional stereo loudspeakers to simulate the effect provided by multichannel audio reproduction technology.

3-D sound technology commonly uses sound image control filters that are designed based on Head-Related Transfer Functions (HRTFs), which represent the acoustic characteristics of sounds from loudspeakers to a listener's ears. Such 3-D sound technology Is disclosed in Non Patent Literature (NPL) 1. However, sound technology disclosed in NPL 1 fails to provide desired signals when the listener's position changes or the listener changes to another listener. The following approaches have been proposed for attenuating the effects caused by a relative positional relationship between the loudspeakers and the listener.

An example is disclosed in Patent Literature (PL) 1, which uses a sound reproduction system referred to as stereo dipole to enable a robust control of a relative displacement between the loudspeakers and the listener. In stereo dipole, an angle defined by the left-hand loudspeaker, the listener, and the right-hand loudspeaker is set between eight to twenty degrees.

Meanwhile, PL 2 discloses a compact loudspeaker unit of the stereo dipole system disclosed in PL 1 that is detachable to and from a game controller.

PL 3 discloses a home-use game system including a controller having loudspeakers in addition to joysticks and buttons. In such a home-use game system, the loudspeakers of the controller reproduce important sound information that should not be missed by the user, for the distance between the user and the controller is shorter that the distance between the user and the television.

### CITATION LIST

### Patent Literature

[Patent Literature 1] Japanese Patent No. 4508295
[Patent Literature 2] Japanese Unexamined Patent Application Publication No. 2004-128669
[Patent Literature 3] Japanese Unexamined Patent Application Publication No. 2014-81727

### Non Patent Literature

[Non Patent Literature 1] “Onkyou sisutemu to dijitaru syori (Acoustic systems and digital technology)” collectively written by Ohga Juro, Yamasaki Yoshio, Kaneda Yutaka, edited and published by Institute of Electronics, Information and Communication Engineers

### SUMMARY

### Technical Problem

As previously stated, to obtain desired 3-D sound effects, the listener is required to listen to sounds at a position that is determined when the sound image control filters are designed. More specifically, the listener is required to stay at a predetermined listener position to listen to sounds from the loudspeakers located at predetermined loudspeaker positions. When the loudspeakers are used to reproduce game sound, the Internal loudspeakers of a television or the loudspeakers located around the television are usually used. Hence, in order to obtain 3-D sound effects from such loudspeakers, the user is required to stay unmoved from a predetermined position when enjoying the game.

Recent game machines have adopted wireless controllers, which allows game users to enjoy games wherever they like so long as they can receive wireless signals. However, the fact that the users are required to play games at limited positions to obtain 3-D sound effects from the game machines means that the users fail to play games at positions of their preferences and thus that they cannot fully enjoy the games.

Moreover, some game software allows plural users to enjoy the same game together. Since it is not easy for plural users to enjoy the same game at the relatively same positions with respect to the loudspeakers, a problem arises that all users cannot obtain 3-D sound effects from games intended for plural users to play together.

Although PL1 discloses a sound image control method that is robust with respect to the movement of a listener, such method falls to allow the user to freely move around with the reproduction loudspeakers being fixed, and thus falls to solve the above problem.

In view of the above, the present disclosure provides a sound reproduction system that enables a user to pleasantly enjoy both normal sounds and 3-D processed sounds without requiring such user to stay at a limited position when receiving the sounds.

### Solution to Problem

To solve the above problem, a sound reproduction system according to an aspect of the present disclosure includes: a sound processing device connected to a first output device including a plurality of first sound output units, the first output device being a stationary device; and a second output device including a plurality of second sound output units, the second output device being a portable device. In such sound reproduction system, the sound processing device generates a first sound output signal to be output to the first output device and a second sound output signal to be output to the second output device, the second sound output signal being different from the first sound output signal, and at least the second sound output signal out of the first sound output signal and the second sound output signal includes a signal that is obtained by performing three-dimensional (3-D) sound processing.

This configuration allows a user to pleasantly enjoy 3-D sound effects independently of the user position, since this configuration enables the user to enjoy both the first sound output signal reproduced from the first output device and the 3-D processed sound reproduced from the portable second output device held by the user.

Further, in the sound reproduction system, the first output device may be capable of reproducing a frequency band signal that is lower than a frequency band signal reproduced by the second output device, and the sound processing device may include a 3-D processing unit, a band division filter, and an addition processing unit. The 3-D processing unit may be configured to perform the 3-D sound processing, the band division filter may divide, at a predetermined cutoff frequency, the second sound output signal or a sound source signal into a low-frequency band signal and a high-frequency band signal, the sound source signal being the second sound output signal before being subjected to the 3-D sound processing, and the addition processing unit may be configured to add the low-frequency band signal to the first sound output signal.

This configuration allows the user to enjoy more excellent 3-D sound effects with little change in sound quality, since the stationary first output device reproduces the low-frequency band signal that Is difficult for the portable second output device to reproduce.

Further, in the sound reproduction system, the sound processing device may further include a delay correction unit configured to correct one of the first sound output signal and the second sound output signal to mitigate perception of a time difference at a listener's position, the time difference being a difference between a time delay of arrival of an output from the first sound output units and a time delay of arrival of an output from the second sound output units.

This configuration reduces a user's feeling of strangeness caused by the time-delay-of-difference since the user's perception is mitigated of a time-difference-of-arrival between the low-frequency components of the second sound output signal delayed by the first output device and the high-frequency components of the second sound output signal reproduced from the second output device.

Here, the delay correction unit may be configured to delay the second sound output signal.

This configuration reduces the user's feeling of strangeness by reducing the time-delay-of-difference itself.

Here, the delay correction unit may be configured to weaken an attack component of the second sound output signal.

This configuration reduces the user's feeling of strangeness by weakening the attack component of the second sound output signal.

Here, the 3-D sound processing may enable a listener to perceive that a virtual sound source is at an ear of the listener.

This configuration provides more realistic 3-D sound effects by generating a sound image at a user's ear.

Here, the 3-D processing unit may be configured to change a position of the virtual sound source according to an operation of the second output device made by the listener.

This configuration provides highly realistic sound reproduction adapted to circumstances.

### Advantageous Effects

The present disclosure enables a game user to pleasantly enjoy both normal sounds and 3-D processed sounds without being required to stay at a limited position when receiving the sounds.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a diagram showing an example configuration of a sound reproduction system according to Embodiment 1.

FIG. 2 is a diagram showing an example configuration of a sound reproduction system according to Embodiment 2.

FIG. 3 is a diagram showing a first variation of the sound reproduction system according to Embodiment 2.

FIG. 4 is a diagram showing a second variation of the sound reproduction system according to Embodiment 2.

FIG. 5 is a diagram showing a third variation of the sound reproduction system according to Embodiment 2.

FIG. 6 is a diagram showing an example configuration of a sound reproduction system according to Embodiment 3.

FIG. 7 is a diagram showing a first variation of the sound reproduction system according to Embodiment 3.

FIG. 8 is a graph showing a window function used by a delay correction unit according to Embodiment 3.

FIG. 9 is a diagram showing a second variation of the sound reproduction system according to Embodiment 2.

FIG. 10 is a diagram showing an example configuration of the 3-D sound reproduction system.

FIG. 11 is a diagram showing an example configuration of the game system.

### DESCRIPTION OF EMBODIMENTS

### (Findings Underlying Present Disclosure)

The inventors have found that the sound reproduction systems (home-use game system) described in “Background” have the problems described below.

First, the 3-D sound technology disclosed in NPL1 is described.

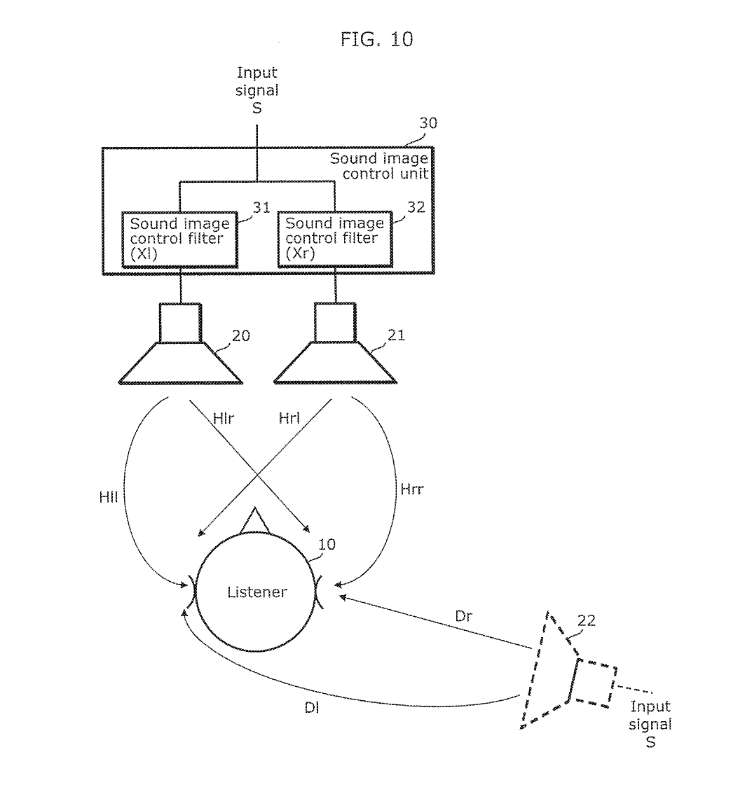

FIG. 10 is a block diagram showing an example configuration of the 3-D sound reproduction system. In the following description, signals and filters are represented in the frequency domain. HRTFs are commonly represented as finite length impulse responses or those converted into frequency domain. In the present disclosure, HRTFs are represented as frequency domain equations. The 3-D sound reproduction system shown in FIG. 10 includes a left-hand loudspeaker 20, a right-hand loudspeaker 21, and a sound image control unit 30. The sound image control unit 30 includes a sound image control filter 31 and a sound image control filter 32. A transfer function of the sound image control filter 31 is represented as Xl, and a transfer function of the sound image control filter 32 is represented as Xr.

This example uses stereo loudspeakers (a left-hand loudspeaker 20 and a right-hand loudspeaker 21) located in front of a listener 10 to duplicate, at the ears of the listener 10, the sound identical to the sound obtained by reproducing an input signal S from a virtual loudspeaker 22 located at the rear of the listener 10. HRTFs from the left-hand loudspeaker 20, the right-hand loudspeaker 21, the left ear of the listener 10, and the right ear of the listener 10 are respectively represented as Hll, Hlr, Hrl, Hrr, and HRTFs from the virtual loudspeaker 22 to the left ear and the right ear of the listener 10 are respectively represented as Dl and Dr. The input signal S here is a 2 channel sound signal. The sound image control filters 31 and 32 perform filtering on the input signal S, and output the filtered signals respectively to the left-hand loudspeaker 20 and the right-hand loudspeaker 21. The sound image control filters 31 and 32 are designed so that a signal identical to the signal obtained by reproducing the input signal S from the virtual loudspeaker 22 can be reproduced at the ears of the listener 10.

More specifically, the following Equation 1 is solved to determine Xl and Xr. Note that * is a symbol of operation representing convolution.

$$\begin{matrix}[ Equation 1 ] & \\ [ \begin{matrix}Hll & Hrl \\ Hlr & Hrr\end{matrix} ] [ \begin{matrix}Xl \\ Xr\end{matrix} ] * S = [ \begin{matrix}Dl \\ Dr\end{matrix} ] * S & ( Equation 1 )\end{matrix}$$

Xl and Xr that satisfy the above equation are determined, for example, by the following Equation 2.

$$\begin{matrix}[ Equation 2 ] & \\ [ \begin{matrix}Xl \\ Xr\end{matrix} ] = {[ \begin{matrix}Hll & Hrl \\ Hlr & Hrr\end{matrix} ]}^{- 1} [ \begin{matrix}Dl \\ Dr\end{matrix} ] & ( Equation 2 )\end{matrix}$$

By determining each of Xl and Xr in the required frequencies by use of Equation 2, then convoluting the determined Xl and Xr into the input signal S to reproduce the resulting signal, the listener 10 can receive, at both ears, a signal identical to the input signal S output from the virtual loudspeaker 22. More specifically, the listener 10 perceives that the sound is coming from the virtual loudspeaker 22, although in fact the sounds are reproduced from the left-hand loudspeaker 20 and the right-hand loudspeaker 21 located in front of such listener 10.

Here, HRTFs include all the acoustic characteristics of sounds between the loudspeakers and the ears of the listener 10. It means that HRTFs vary when a relative positional relationship between the loudspeakers and the listener 10 changes and when the listener 10 changes to another listener. In a precise sense, the characteristics (transfer functions) determined above for the image control filters 31 and 32 are desired characteristics, i.e., Dl*S and Dr*S can be duplicated at the positions of both ears of the listener 10, in the case where the listener 10 by him/herself measures HRTFs and listens to the sounds controlled by the image control filters 31 and 32 at the positions where such listener 10 has measured the HRTFs. Consequently, a desired signal cannot be necessarily obtained when the listener's position changes and the listener 10 changes to another listener.

To cope with this, a dummy head is commonly used for HRTF measurement. A dummy head, which is a replica of a human head or bust, is made in accordance with the shapes and dimensions of the head and pinna of a standard human head. The use of a dummy head allows for HRTF measurement of a standard human, and thus for the reduction of the effects caused by individual differences in HRTFs.

Meanwhile, there is a home-use game system, which is another example of the sound reproduction system, including a controller with loudspeakers in addition to joysticks and buttons. A new type of entertainment has been proposed by a combined use of the loudspeakers of a television connected to such a home-use game machine and the Internal loudspeakers of the controller.

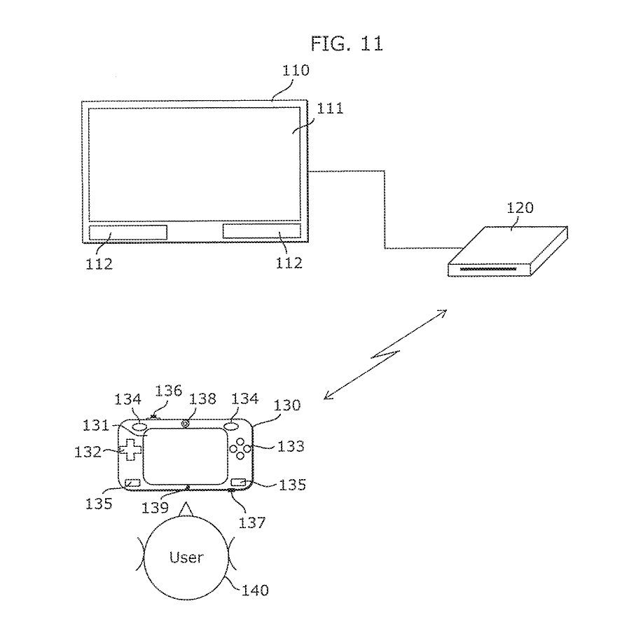

FIG. 11 is a diagram showing an example configuration of the game system, which is an example of the sound reproduction system and which is disclosed in PL 3, using the television loudspeakers and the internal loudspeakers of a controller. Such game system includes a television 110, a game machine body 120 connected to the television 110, and a controller 130. The television 110 includes a television screen 111 and two television loudspeakers 112. The controller 130 includes a controller screen 131, a cross key 132, control buttons 133, joysticks 134, loudspeakers 135, a controller volume slider 136, a headphone jack 137, a camera 138, and a microphone 139.

The television 110 and the game machine body 120 are connected typically via an HDMI™ cable or the like. A video signal of a game from the game machine body 120 is output onto the television screen 111 and an audio signal of the game from the game machine body 120 is output from the television loudspeakers 112. The game machine body 120 is also connected to the controller 130 wired or wirelessly. The controller 130 is used by a user 140 for game operations and other purposes. The controller 130 includes the loudspeakers 135, from which an audio signal identical to or different from an audio signal from the television loudspeakers 112 is output, according to the progress of the game and user operations. PL3 discloses that the loudspeakers of the controller reproduce important sound information that should not be missed by the user. This technology, however, has a problem in that the loudspeakers 135 of the controller 130 reproduce no 3-D sound, and further in that such loudspeakers 135 have a poor capability of reproducing the low frequencies because of their compactness, making it difficult for such loudspeakers 135 to effectively reproduce 3-D sounds.

Meanwhile, PL2 discloses the use of the Internal loudspeakers of a controller to provide 3-D sound effects. However, typical loudspeakers that can be integrated into a controller are incapable of reproducing sounds in a low-frequency band of some hundreds of Hz or lower. Recent game software is adapted to multichannel audio, and thus is capable of enabling the user to enjoy the game with powerful sounds, when the user can play the game in an environment that allows multichannel sound reproduction through home-theater speakers such as 5.1 home-theater speaker systems. However, the internal loudspeakers of a controller are not enough to fully provide such powerful sounds. Not only from the perspective of the sound powerfulness, the conventional technology is incapable of reproducing the low-frequency components of some signals to be reproduced, resulting in a change in their sound quality and thus gives the user a feeling of strangeness. Moreover, the conventional technology also has a problem in that the 3-D effects of 3-D processed sounds are reduced and thus that the user cannot enjoy realistic sound reproduction, with the low-frequency sounds being unreproduced.

Against this backdrop, the inventors have found that effective 3-D sound reproduction is achieved by use of the loudspeakers 135 of the controller 130 in the sound reproduction system (game system) as described above.

In view of the above, the present disclosure is aimed at providing a sound reproduction system that enables a user to pleasantly enjoy both normal sounds and 3-D processed sounds without requiring the user to listen to the sounds at a limited position.

### Embodiment 1

The following describes in detail embodiments of the present disclosure with reference to the drawings where necessary. It should be noted that some of the unnecessarily detailed descriptions, e.g., descriptions about the well-known facts and repeated descriptions about the same structural elements maybe eliminated in the following. Such elimination is intended to avoid the following description from becoming unnecessarily redundant and lengthy and thus to help those skilled in the art to easily understand the present disclosure.

Also note that the following description and accompanied drawings are provided by the inventors to help those skilled in the art to fully understand the present disclosure, and thus that they are not Intended to limit the scope of the subject recited in Claims.

The following describes the embodiments of the present disclosure with reference to the drawings.

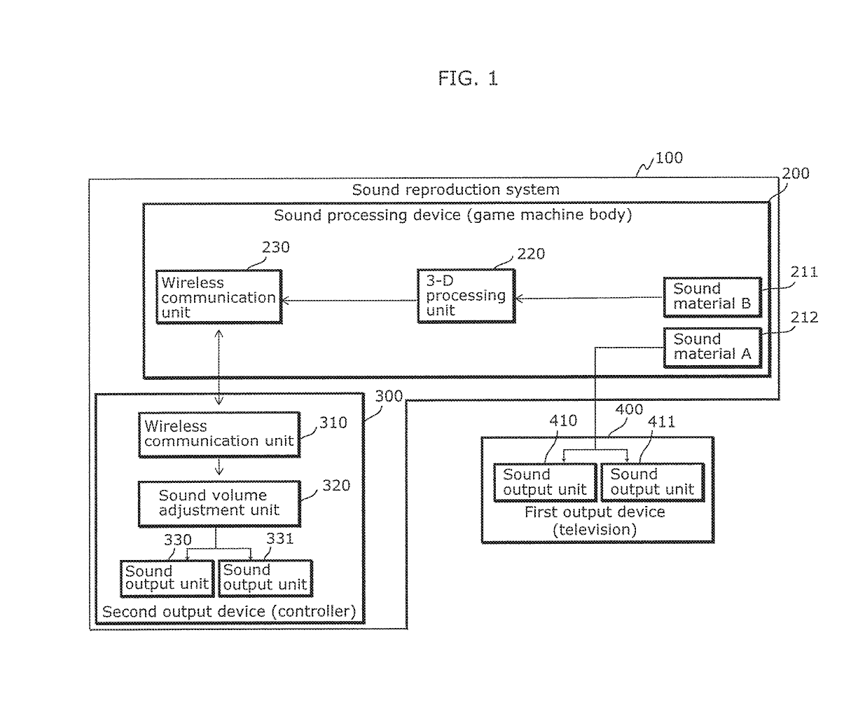

FIG. 1 is a diagram showing an example configuration of a sound reproduction system 100 according to Embodiment 1. The following describes an example case of applying the sound reproduction system 100 to the game system shown in FIG. 11. The following mainly describes sound processing out of video processing and sound processing performed in the game system.

The sound reproduction system 100 is connected to a first output device 400, and includes a sound processing device 200 and a second output device 300. The first output device 400, the second output device 300, and the sound processing device 200 shown in FIG. 1 are respectively applied to the television 110, the game machine body 120, and the controller 130.

The sound processing device 200, which is a game machine body here, executes processing such as game processing based on, for example, a game program recorded in a readable optical disk. Such game processing includes video processing and sound processing.

The first output device 400, which is a television here, includes plural sound output units 410 and 411, serving as loudspeakers (hereinafter referred to as television loudspeakers 410 and 411). The first output device 400 is connected to the sound processing device 200, serving as a game machine body, typically via an HDMI™ cable or the like. According to the progress of a game, a video signal of the game from the sound processing device 200, serving as a game machine body, is output from a television screen 111 of the first output device 400, and an audio signal for the television (first sound output signal) from the sound processing device 200 is reproduced and output from the television loudspeakers 410 and 411.

The sound processing device 200, serving as a game machine body, is also connected the second output device 300 (controller) wired or wirelessly. The sound processing device 200 generates a first sound output signal to be output to the first output device 400 and a second sound output signal, which is different from the first sound output signal, to be output to the second output device 300. Of the first and second sound output signals, at least the second sound output signal includes a 3-D processed sound signal obtained by the sound processing device 200 by performing 3-D sound processing.

The second output device 300, which is a game controller here, includes sound output units 330 and 331, serving as loudspeakers (hereinafter referred to as loudspeakers 330 and 331). The second output device 300 may have the same configuration as that of the controller 130 shown in FIG. 11, and includes joysticks and the like. The second output device 300 is held in the hand(s) of a user enjoying the game who operates the second output device 300. The sound processing device 200, as a game machine body, controls the progress of the game according operations of such user. The second output device 300 reproduces an audio signal for the controller (second sound output signal) sent from the sound processing device 200, according to the progress of the game. Although the loudspeakers 330 and 331 are described here as 2 channel loudspeakers, the loudspeakers 330 and 331 may alternatively be 3 or more channel loudspeakers. The second output device 300 includes a sound volume adjustment unit 320, by which the sound volume of the second sound output signal to be reproduced from the loudspeakers 330 and 331 can be adjusted according to, for example, the user's operating the sound volume adjustment slider included in the second output device 300.

Audio signals recorded in the game program are stored, as a sound material B211 and a sound material A212, in an internal memory or the like in the sound processing device 200, which serves as a game machine body.

The 3-D processing unit 220 performs 3-D sound processing on the sound material B211, and the resulting 3-D processed sound signal is reproduced from the loudspeakers 330 and 331 as the second sound output signal. This enables the sound material B211 to provide the effect as if the sound has been coming from around the user's ears. The 3-D sound processing here is not limited to the localization of a sound image at the user's ears and thus other localization positions may be achieved. An example configuration of the 3-D processing unit 220 is the same as that of the sound image control unit 30 shown in FIG. 10, and includes the sound image control filter 31 and the sound image control filter 32. Although the sound image control filters 31 and 32 are commonly materialized as Finite Impulse Response (FIR) filters, the sound image control filters 31 and 32 may also be materialized as Infinite Impulse Response (IIR) filters or may be materialized by combining plural FIR filters and IIR filters, other than having the configuration of FIR filters. The characteristics of the sound image control filters 31 and 32 are set, for example, by use of the method that is described above using Equations 1 and 2. In FIG. 10, a sound image is localized at one position of the virtual loudspeaker 22 for each input signal. To localize different input signals at different virtual loudspeaker positions shown in FIG. 1, the image control unit 30 may be provided by an amount equal to the number of virtual loudspeaker positions so that sound image control processing can be performed for the respective sound sources.

The sound material B211 that has been 3-D processed by the 3-D processing unit 220 is sent, as the second sound output signal, to a wireless communication unit 230 to be converted into a wireless communication signal, and sent to the second output device 300. The second sound output signal is extracted from the wireless communication signal by a wireless communication unit 310 included in the second output device 300 that has received the wireless communication signal. The sound volume of the extracted second sound output signal is adjusted by the sound volume adjustment unit 320 and subsequently reproduced from the loudspeakers 330 and 331.

The sound material A212 is reproduced from the television loudspeakers 410 and 411 as the first sound output signal. The sound material A212 may be typically created such that the user can perceive that the sound is coming from the frontal direction when the loudspeakers are two loudspeakers, as in the case of the television loudspeakers 410 and 411.

Consequently, the user perceives that the second sound output signal obtained by performing 3-D sound processing on the sound material B211 is coming from around the user's ears and that the sound material A212 is coming from the television loudspeakers 410 and 411 as the first sound output signal. This means that the user perceives individual sound images at different positions, and thus that the present disclosure is capable of providing more realistic audio reproduction than audio reproduction provided by the conventional sound reproduction systems (game system) such as one disclosed in PL 3, in which the user perceives sound images at the positions of television loudspeakers and at the positons of controller loudspeakers. In a horror game, for example, the present disclosure enables to provide sound images of the video with higher fidelity by using, as the sound material B211, the sounds of a zombie assaulting a game character from behind and by using, as the sound material A212, the background sound. More realistic audio reproduction is thus achieved than audio reproduction provided by the conventional game systems.

Furthermore, the provision of plural second output devices 300 (controllers) enables plural users to enjoy the same audio reproduction. With the second output devices 300 used in the users' hands, plural users can individually enjoy 3-D effects of the sounds reproduced from the loudspeakers 330 and 331. It is of course possible to provide different audio reproductions for different individual users by providing plural sound materials A211 and 3-D processing units 220 to enable the sending of different signals to different controllers.

Note that although the television loudspeakers 410 and 411 are commonly stereo loudspeakers, the first output device 400 may Include 3 or more channel loudspeakers. Instead of including the television loudspeakers 410 and 411, the first output device 400 may alternatively include a bar-shaped loudspeaker with an amplifier known as soundbar and the like, or may be separately connected, via an AV amplifier, to a home theater loudspeaker system such as 5.1 channel. The use of 5.1 channel loudspeakers enables the user to perceive the sound material A212 as coming from the rear direction, in addition to from the frontal direction, and thus to provide a much richer audio reproduction.

### Embodiment 2

In Embodiment 2, a sound reproduction system is described in which the first output device 400, which is a stationary device, reproduces a low-frequency sound signal included in the second sound output signal. The reproduction of such a low-frequency sound signal is difficult for the second output device 300, which is a portable device, or information included is likely to be missing at the time of reproduction.

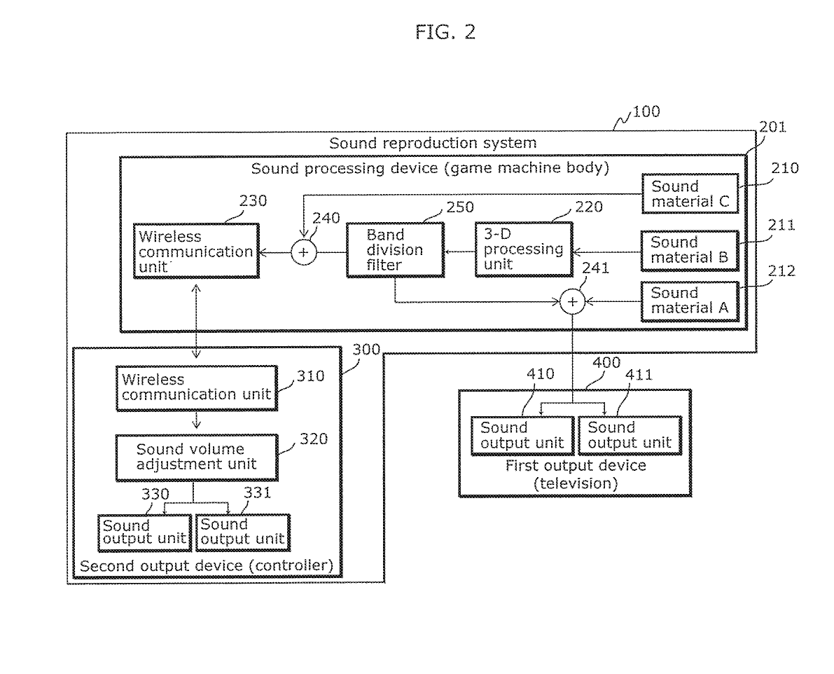

FIG. 2 is a diagram showing an example configuration of the sound reproduction system 100 according to Embodiment 2. Embodiment 2 is described as an example of applying the present disclosure to a game system, as in the case of Embodiment 1. A sound processing device 201 shown in FIG. 2 is the same as the sound processing device 200 shown in FIG. 1 except that the sound processing device 201 further includes a sound material C210, a band division filter 250, and addition processing unit 240 and 241. The following description focuses mainly on such differences.

The band division filter 250 divides, at a predetermined cutoff frequency, the second sound output signal or the sound source signal, which is the second sound output signal before being subjected to the 3-D processing (i.e., the sound material A212), into a low-frequency band signal (i.e., low-frequency components) and a high-frequency band signal (i.e., high-frequency components). In FIG. 2, the band division filter 250 band-divides the second sound output signal that has been 3-D processed, rather than the sound source signal.

The addition processing unit 241 adds the above-described low-frequency band signal to the first sound output signal, and outputs the resulting signal to the first output device 400.

The addition processing unit 240 adds the above-described high-frequency band signal to the sound signal of the sound material C210, and outputs the resulting signal to the second output device 300. The sound material C210 is reproduced from the loudspeakers 330 and 331 without being 3-D processed.

As previously stated, the second output device 300 is typically operated in the user's hand(s). Consequently, compact loudspeakers with a diameter of a few centimeters intended for mobile devices are usually used as the loudspeakers 330 and 331 integrated into the second output device 300. The loudspeakers 330 and 331 commonly have smaller diameters than those of the television loudspeakers 410 and 411. This means that the low-frequency band limit reproducible by the loudspeakers 330 and 331 is higher than that of the television loudspeakers 410 and 411, i.e., the loudspeakers 330 and 331 are less capable of reproducing the low-frequency components than the television loudspeakers 410 and 411. Loudspeakers that have received an audio signal below their reproducible low-frequency band limit can reproduce such audio signal at lower sound volume levels than the actual input level, and thus the user can perceive that the sound quality has changed when listening to, for example, a male voice from such loudspeakers. Furthermore, when the user perceives that the sound volume is too small and increases the input level excessively, the loudspeaker unit itself may be subjected to damage.

To solve this problem, the band division filter 250 is adopted as shown in FIG. 2. The band division filter 250 divides the second sound output signal into high-frequency components and low-frequency components at a predetermined cutoff frequency, e.g., at around the low-frequency band limit reproducible by the loudspeakers 330 and 331 (typically at around some hundreds of Hz in the case of loudspeaker units for mobile devices, although it depends on the diameters and performances of loudspeakers). Of the second sound output signal output from the 3-D processing unit 220, the band division filter 250 outputs the high-frequency components to the addition processing unit 240 and outputs the low-frequency components to the addition processing unit 241. Of the second sound output signal obtained by performing the 3-D sound processing on the sound material B211, the high-frequency components are added with the sound signal of the sound material C210 to be reproduced from the loudspeakers 330 and 331 and the low-frequency components are added with the first sound output signal to be reproduced from the television loudspeakers 410 and 411.

This enables a low-frequency signal of the sound material B211, which cannot be reproduced from the loudspeakers 330 and 331, to be reproduced from the television loudspeakers 410 and 411 instead of the loudspeakers 330 and 331, and thus to reduce the possibility of missing the information of the low-frequency components. For example, although the information can be missing in the method shown FIG. 1 as a result of trying in vain to reproduce, only from the loudspeakers 330 and 331, the background sound that includes only the low-frequency components, the sound processing device 201 shown in FIG. 2 is capable of reducing the possibility of missing the Information, because the low-frequency components are reproduced from the television loudspeakers 410 and 411. The sound processing device 201 is also capable of reducing changes in the sound quality of the low-frequency components, such as male voices, to be reproduced from the loudspeakers 330 and 331. Consequently, the present disclosure enables audio reproduction with higher fidelity that is closer to the audio reproduction originally intended by the game developers.

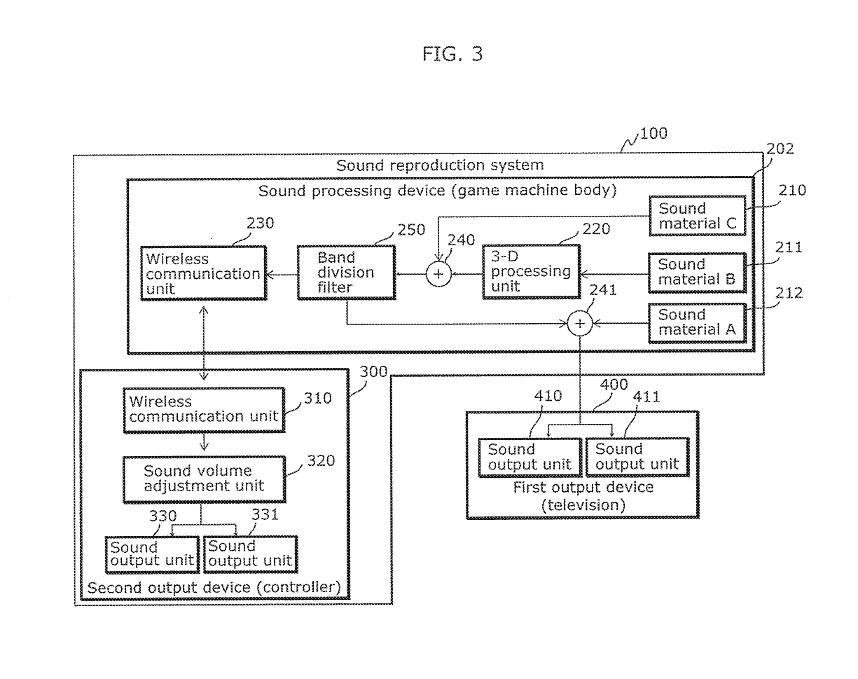

Note that the sound reproduction system 100 may include a sound processing device 202 as shown in FIG. 3 instead of the sound processing device 201. FIG. 3 is a diagram showing a first variation of the sound reproduction system according to Embodiment 2. Referring to FIG. 3, the sound processing device 202 is different from the sound processing device 201 in that the addition processing unit 240 is disposed in the preceding stage of the band division filter 250, rather than the subsequent stage. The outputs from the addition processing unit 240 include the sound signal of the sound material C210, in addition to the second sound output signal. Accordingly, the band division filter 250 band-divides the sound signal of the sound material C210 in addition to the second sound output signal, and respectively outputs the high-frequency components to the wireless communication unit 230 and the low-frequency components to the addition processing unit 241. This configuration produces an advantage that the low-frequency components of the sound material C210 can be reproduced by use of the television loudspeakers 410 and 411 with no information missing.

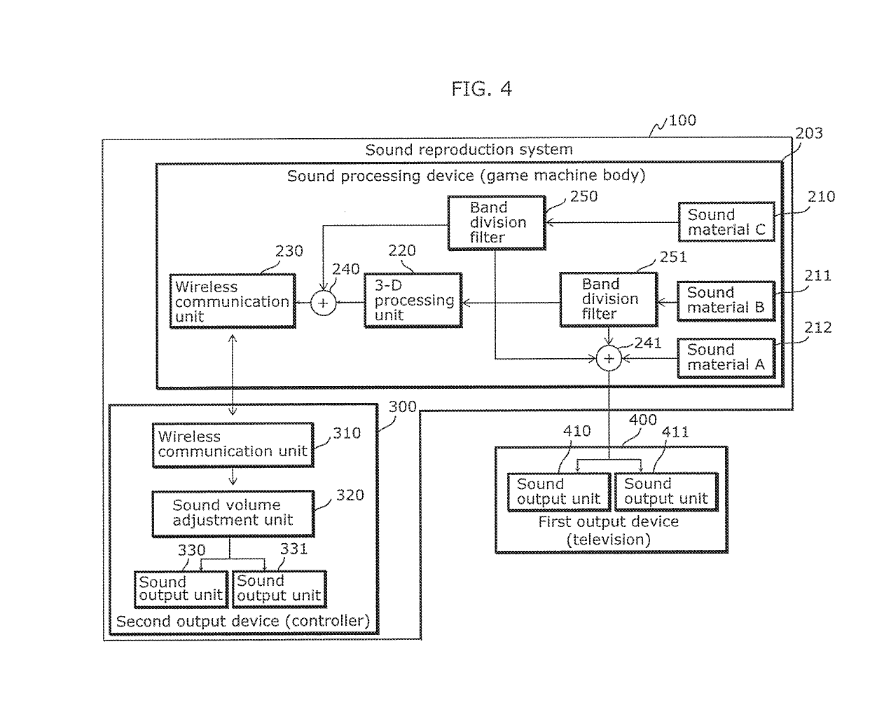

Alternatively, the sound reproduction system 100 may include a sound processing device 203 as shown in FIG. 4 instead of the sound processing device 201. FIG. 4 is a diagram showing a second variation of the sound reproduction system according to Embodiment 2. The sound processing device 203 is different from the sound processing device 201 in that the sound processing device 203 further includes a band division filter 251 and in that the band division filter 250 is disposed differently.

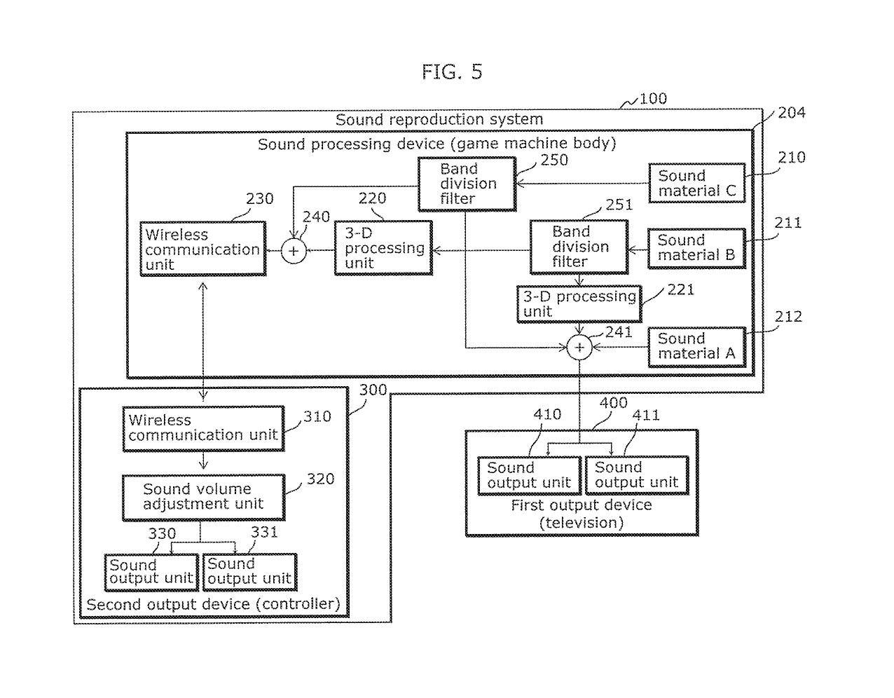

Furthermore, the sound reproduction system 100 may Include a sound processing device 204 as shown in FIG. 5 instead of the sound processing device 203. FIG. 5 is a diagram showing a third variation of the sound reproduction system according to Embodiment 2. The sound processing device 204 is different from the sound processing device 203 in that the sound processing device 204 further includes a 3-D processing unit 221. As shown in this example, the output from the band division filter 251 (low-frequency components) may be separately 3-D processed by the 3-D processing unit 221 for the reproduction from the television loudspeakers 410 and 411. Here, it is desirable that the 3-D processing unit 220 and the 3-D processing unit 221 produce the same 3-D effects. More specifically, both the 3-D processing unit 220 and the 3-D processing unit 221 are desirably capable of localizing sound sources at, for example, the user's ears. This enables the achievement of stronger 3-D effects.

### Embodiment 3

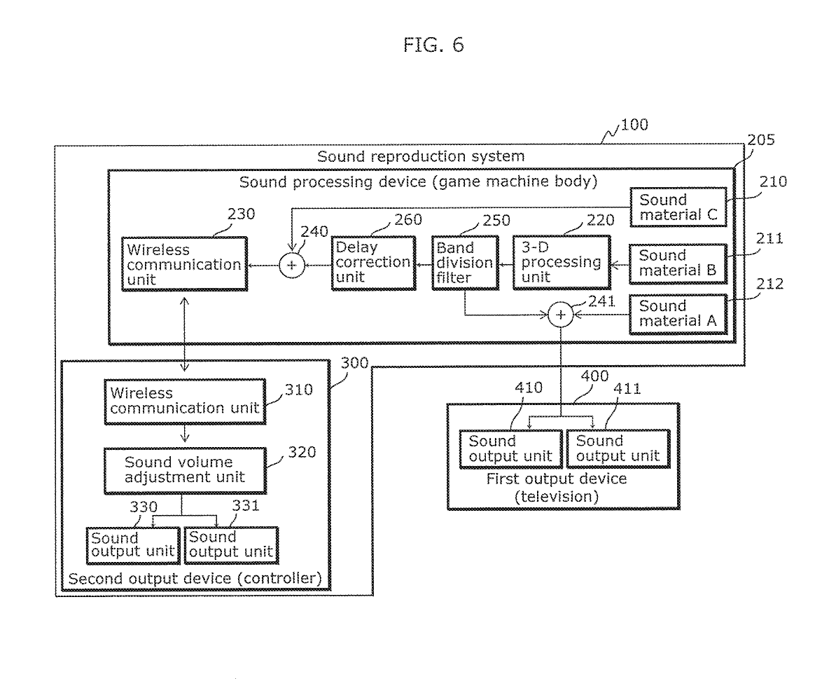

FIG. 6 is a diagram showing an example configuration of a sound reproduction system according to Embodiment 3 of the present disclosure. Embodiment 3 is described as an example case of applying the sound reproduction system according to one aspect of the present disclosure to a game system, as in the case of Embodiments 1 and 2.

FIG. 6 is different from FIG. 2 in that a delay correction unit 260 is further included. The following description focuses mainly on such difference.

There is a time delay between the times from when the sound processing device 200 shown in FIG. 2 outputs the video and the second sound output signal to the first output device 400 (television) to when the television screen and the television loudspeakers 410 and 411 actually output the received video and second sound output signal, respectively. There is also a time delay between the times from when the sound processing device 200 outputs the first sound output signal to the second output device 300 to when the loudspeakers 330 and 331 actually output the received first sound output signal. These time delays are more often different than the same. In other words, the 3-D processing unit 220 basically needs to reproduce, as its outputs, the low-frequency components and the high-frequency components synchronously, i.e., there should be no difference between these time delays. However, the television loudspeakers 410 and 411 reproduce the sound behind time by an amount of such time delay difference, affecting the user's sound perception. To solve this problem, a sound processing device 205 shown in FIG. 6 adopts the delay correction unit 260. The delay correction unit 260 generates a delay to cancel out the above-described time delay difference that is generated when the television loudspeakers 410 and 411 reproduce the sound. This enables the respective sounds from the loudspeakers 330 and 331 and the television loudspeakers 410 and 411 to be reproduced with no time difference.

A time delay of arrival of an output from the first output device 400 typically varies depending on the model and operation mode of the first output device 400, and thus the user may be allowed to adjust a time delay to be corrected by the delay correction unit 260. For example, the user may correct the time delay in the unit of ms, or may select the optimal time delay pattern that gives no feeling of strangeness to such user, from among several given typical patterns of time delays.

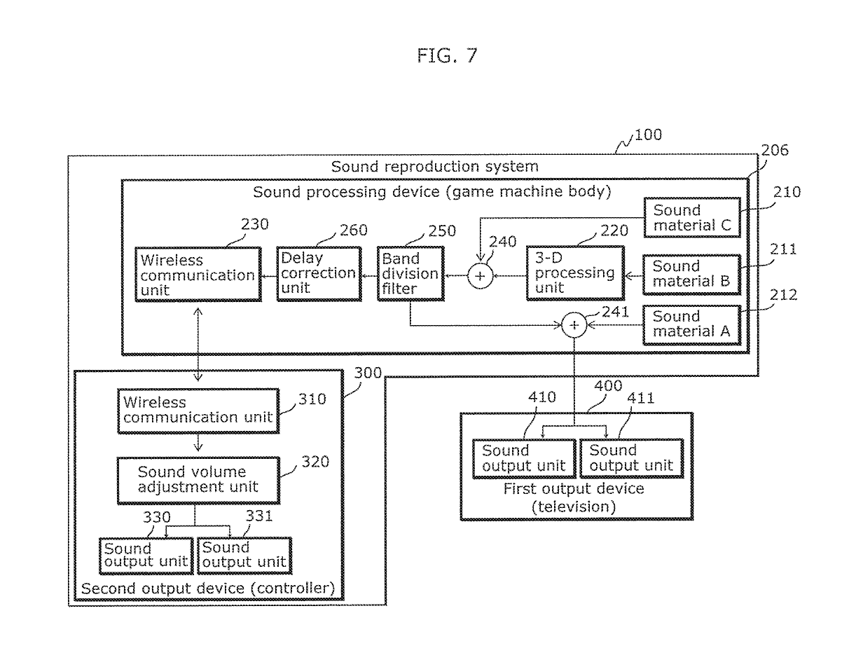

Alternatively, the delay correction unit 260 may be disposed between the band division filter 250 and the wireless communication unit 230 as in a sound processing device 206 shown in FIG. 7. FIG. 7 is a diagram showing a first variation of the sound reproduction system according to Embodiment 3. Referring to FIG. 7, it is possible to synchronously reproduce all audio signals in the sound reproduction system 100 because a time delay difference is corrected between all signals output from the loudspeakers 330 and 331 and signals reproduced from the television loudspeakers 410 and 411.

Furthermore, the sound processing devices 202 and 203 respectively shown in FIGS. 3 and 4 may include the delay correction unit 260 as shown in FIG. 7.

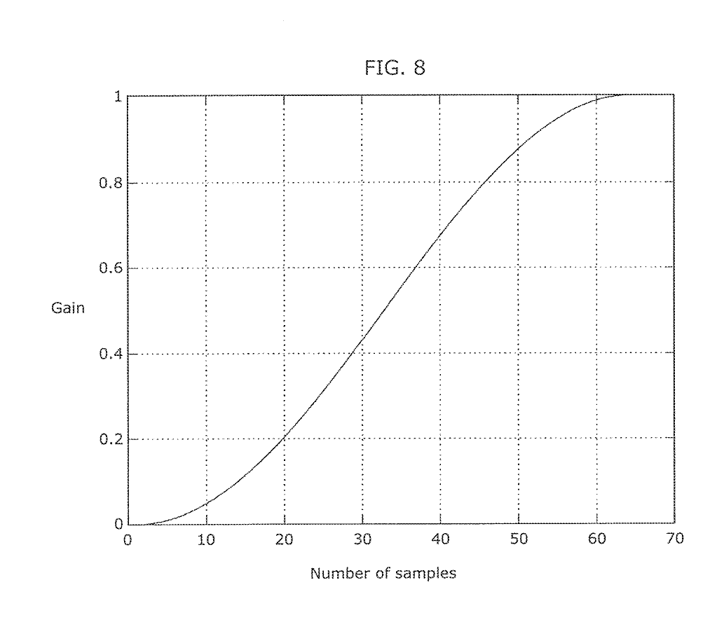

The results of experiments conducted by the inventors show that a user perception is more likely to be affected by time delays of sound signals with sharp attack. In view of this, the delay correction unit 260 shown in FIG. 6 may alternatively weaken an attack component of the second sound output signal, rather than generating a time delay. For example, the delay correction unit 260 may multiply the window function as shown in FIG. 8 with the attack component of the second sound output signal. FIG. 8 is a graph showing an example window function used by the delay correction unit 260 according to Embodiment 3. In the graph of FIG. 8, the horizontal axis represents the number of samples and the vertical axis represents the gain to be multiplied. This graph corresponds to an extracted first half of the Hann window. The multiplication of such window function with an audio signal enables to lessen the sharp attack of the sound, and thus to mitigate the user's perception of a time-difference-of-arrival between the loudspeakers 330 and 331 and the television loudspeakers 410 and 411. Note that the window function shown in FIG. 8 is an example, and thus another window shape and another window length (the number of samples taken by the gain to rise from zero to unity) may be used. Example window shapes that may be used include the Hann window and the Hamming window, which allow the gain to smoothly rise from zero to unity. Furthermore, a sound signal with a sharp attack may be detected so that the low-frequency components of such signal are not to be output (i.e., reproduced only from the loudspeakers 330 and 331). To enable such detection to be performed in real time, a detection unit may be provided that detects the sharpness of the attack of a sound, so that the low-frequency components of such sound cannot be output when the sharpness detected by the detection unit exceeds a certain threshold. For example, all gain values of the window function shown in FIG. 8 are set to zero, or a switch may be separately provided that controls the outputs of low-frequency components so that low-frequency components cannot be output according to the turning on/off of the switch.

In the 3-D sound processing performed by the 3-D processing unit 220 according to Embodiments 1 to 3, the positions of virtual sound sources may be changed by an external control and the characteristics themselves may be changed of the sound image control filters 31 and 32 used for 3-D sound processing. Example methods of changing the positions of virtual sound sources Include a method that reflects the user's control through joysticks. Audio reproduction in a game gives the user a deeper sense of immersion if such audio reproduction can make the user feel as if the user him/herself has become a game character. The audio sounds to be reproduced may be changed according to the user's operating, through the joysticks, a game character appearing in the game software. More specifically, when the face direction or the standing position of a game character is changed through joystick operation, the positions of sound sources in the game (e.g., the sound of gunfire and the voice of another character) are changed accordingly. This enables the user to feel as if such user has become a game character and has entered the world of the game. The sound processing device 205, as a game machine body, calculates distances and directions between a game character and all or one or more specified positions of sound sources, so as to perform 3-D sound processing based on virtual sound source positions that have been changed according to the calculated distances and directions. In so doing, sound materials that are normally reproduced from the television loudspeakers 410 and 411 and the second output device 300 may also be changed by such processing as panning, in addition to the 3-D sound processing. In the case where the positions of virtual sound sources in the 3-D sound processing are the same as or close to the positions of the television loudspeakers 410 and 411 and the loudspeakers 330 and 331, the sounds may be reproduced, without being 3-D processed, from the television loudspeakers 410 and 411 or from the loudspeakers 330 and 331. For example, when a car in the game is approaching from ahead of a game character on the right, passing through just the right side of such character and then driving away toward right rear of the character, the volume of the car sounds reproduced from the right-hand loudspeaker of the television loudspeakers 410 and 411 is gradually increased and then lowered, and the sound volume of the normal outputs from the loudspeakers 330 and 331 is gradually increased accordingly. Afterwards, the sound volume of the normal outputs from the loudspeakers 330 and 331 is lowered, and the sound volume of the 3-D outputs from the loudspeakers 330 and 331 is gradually increased and then gradually lowered. In so doing, such 3-D sound processing is performed as allows the user to perceive that the sound source is at the user's right ear. This processing enables the user to feel as if the car has been approaching from ahead of the user on the right and then driving away.

Furthermore, the sound image control filters may be switched to another, based on the result of face recognition that has been performed by use of an image of an internal camera of the second output device or the like. As previously stated, the effects of the sound image control filters 31 and 32 vary when the listener changes to another listener. For example, the user's characteristics such as gender and face size are detected through face recognition, so that the optimal sound image control filter can be selected on the basis of the result of the face recognition, from among the previously provided sound image control filters. This allows for sound image control with higher accuracy than in the case of using the sound image control filters 31 and 32 that are designed on the basis of HRTFs of a dummy head.

Furthermore, 3-D processed sound signal may be reproduced with the sound volume of other sound signals lowered. This enables the 3-D processed sounds to be accentuated, and thus further increases the reality of the sounds.

In the above embodiments, the sound material C210, the sound material B211, and the sound material A212 may be reproduced at the same time, or one or more of these sound materials may be selected and reproduced.

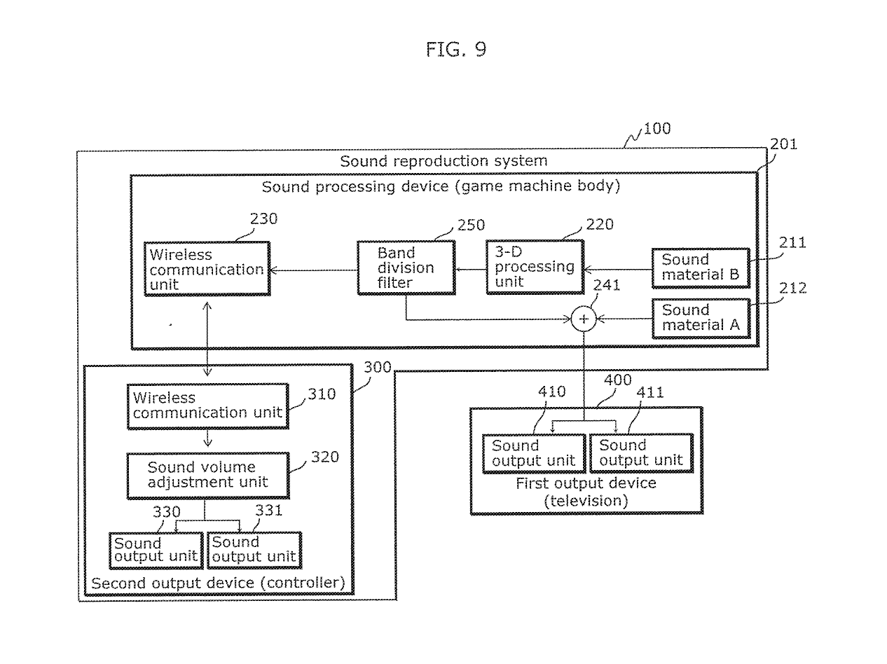

FIG. 9 is a diagram showing a second variation of the sound reproduction system according to Embodiment 2. As shown in FIG. 9, the effectiveness of the present disclosure is maintained in the absence of the sound material C210.

In Embodiments 1 to 3, although the real-time processing is performed on the sound material C210, the sound material B211, and the sound material A212, predetermined processing may be previously performed on one or more or all of these sound materials instead of real-time processing, and the results of such predetermined processing may be stored in the game software for reproduction. This eliminates the necessity of real-time processing performed by the 3-D processing unit, the band division filter 250, and the delay correction unit 260, and thus leads to a lower processing load of the sound processing device 200.

Moreover, in the above embodiments, the structural elements may be materialized as dedicated hardware elements or may be realized by executing software suited to such structural elements. Alternatively, the structural elements may be realized by the reading and execution, by a program execution unit such as a CPU or a processor, of a software program recorded in a recording medium such as a hard disk or a semiconductor memory.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are Intended to be included within the scope of the present disclosure.

### INDUSTRIAL APPLICABILITY

The sound reproduction system according to the present disclosure allows its user to pleasantly enjoy audio reproduction and 3-D sound effects even when such user moves, and thus is widely applicable to sound reproduction systems.

1. A sound reproduction system, comprising:
a sound processing device connected to a first output device including a plurality of first sound output units, the first output device being a stationary device; and
a second output device including a plurality of second sound output units, the second output device being a portable device,
wherein the sound processing device generates a first sound output signal to be output to the first output device and a second sound output signal to be output to the second output device, the second sound output signal being different from the first sound output signal, and
at least the second sound output signal out of the first sound output signal and the second sound output signal includes a signal that is obtained by performing three-dimensional (3-D) sound processing.

2. The sound reproduction system according to claim 1,
wherein the first output device is capable of reproducing a frequency band signal that is lower than a frequency band signal reproduced by the second output device,
the sound processing device includes a 3-D processing unit, a band division filter, and an addition processing unit,
wherein the 3-D processing unit is configured to perform the 3-D sound processing,
the band division filter divides, at a predetermined cutoff frequency, the second sound output signal or a sound source signal into a low-frequency band signal and a high-frequency band signal, the sound source signal being the second sound output signal before being subjected to the 3-D sound processing, and
the addition processing unit is configured to add the low-frequency band signal to the first sound output signal.

3. The sound reproduction system according to claim 2,
wherein the sound processing device further includes a delay correction unit configured to correct one of the first sound output signal and the second sound output signal to mitigate perception of a time difference at a listener's position, the time difference being a difference between a time delay of arrival of an output from the first sound output units and a time delay of arrival of an output from the second sound output units.

4. The sound reproduction system according to claim 3,
wherein the delay correction unit is configured to delay the second sound output signal.

5. The sound reproduction system according to claim 3,
wherein the delay correction unit is configured to weaken an attack component of the second sound output signal.

6. The sound reproduction system according to claim 1,
wherein the 3-D sound processing enables a listener to perceive that a virtual sound source is at an ear of the listener.

7. The sound reproduction system according to claim 6,
wherein the 3-D processing unit is configured to change a position of the virtual sound source according to an operation of the second output device made by the listener.
